(19) United States
(12) Patent Application Publication
(10) Pub. No.: US 2006/0075087 A1
(43) Pub. Date: Apr. 6, 2006

(54) Method and platform for the automated management of distributed system, corresponding telecommunications network and computer program product

(76) Inventors: Gail E. Kaiser, New York, NY (US); Giuseppe Valetto, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/555,454

(22) PCT Filed: Feb. 17, 2004
(86) PCT No.: PCT/EP04/01483

§ 371 Date: Nov. 2, 2005

(30) Foreign Application Priority Data
May 2, 2003 (IT) TO2003A000327

(51) Int. Cl. G06F 15/173

(52) U.S. Cl. 709/224

(57) ABSTRACT

A method for managing a distributed system having processing modules and based on the execution of at least a process within a process engine, which is possibly decentralised, entails interventions for run-time adaptation of the processing modules accomplished by means of effectors. A uniform implementation surface configured to interact with the effectors in transparent fashion relative to the technological implementation peculiarities of the effectors themselves. Preferably, the interface has associated therewith a repository of the effectors as well as an implementation module for selecting, instancing, invoking and managing the effectors according to the tasks implemented in the process. The related platform can be used, for instance, to manage personal messaging in a telecommunications network.

### FIELD OF THE INVENTION

The present invention relates to the techniques that allow to automate and co-ordinate operations for managing distributed processing systems.

The term “management” is used herein in its broadest meaning and it should therefore be construed as inclusive of optimization, administration functions as well as the other forms of adaptation of the aforesaid systems, generally conducted under run-time conditions (i.e. whilst the system is operating). All this in order to assure their correct and optimised operation both in view of changes of the environmental conditions in which they operate and in relation to the operations that such systems perform.

### DESCRIPTION OF THE RELATED ART

In the sector of distributed computing techniques there emerges the problem given by the fact that intervening on complex distributed applications—constituted by a certain number of components interacting by means of protocols and functions (sometimes called connectors), can be rather difficult, costly and time consuming.

The term “run-time adaptation” (especially in regard to software functions) herein is meant to indicate all activities linked to the fact that one intervenes on systems and services which are in operation—usually called target applications—to change them or modify them in relation to some aspects of their operation.

In particular, the function of adapting the software components in run-time conditions is considered in the documents according to the art under different points of view, using concepts like: dynamic adaptation, continued validation, run-time management, system steering, run-time administration, autonomic computing, recovery-oriented computing, and other names.

In computing systems with distributed processing it often occurs that to adapt a certain application it is necessary to deactivate it at least partially in order to perform the necessary administration actions on one or more components. Naturally, during the deactivation period, users of the application do not have available its services.

Therefore, methods and tools have been designed and built which allow to perform various adaptation operations whilst maintaining the operating condition of the application.

Somewhat schematically, such solutions can be classified according to some fundamental categories.

A first category is identified by the relationship with the target application: run-time adaptation facilities can operated from within (in which case they are called internalised) or from the exterior (in which case they are called externalised). An adaptation facility of the first type (internalized) is embedded or incorporated with the related application, representing in practice an extra-functional appendix of the target application.

This type of solution is often described with names containing the prefix “self”, i.e. with terms such as: self-governing, self-managing, self-adapting, self-optimising, self-configuring, self-healing or self-restoring. Internalised facilities are often in the form of a so-called middleware, specialised for the construction of distributed software application with native run-time adaptation characteristics. On the other hand, externalised adaptation facilities are superimposed on the target system by means of a separate software entity (from now on termed platform) dedicated for this purpose.

Another classification category is linked to the degree of automation. Run-time adaptation facilities can be completely assisted by a human operator, partially automated or fully automated.

Yet another classification category is linked to the achievable granularity level: in practice, the distinction depends on which elements and functional and extra-functional aspects of the target application the adaptation can influence.

Lastly, another classification category is linked to the types of adaptations considered: hence, it is possible to consider application deployment/re-deployment, application scalability, application survivability, configuration/reconfiguration of the application, of individual components or connectors, and other kinds of adaptations.

The work by J. M. Cobleigh et al. “Containment Units: A Hierarchically Composable Architecture for Adaptive Systems”, in the 10th International Symposium on the Foundations of Software Engineering (FSE 10), Charleston, S.C., November 2002 contains, within the field of the invention, the description of a typical example of internalised facility for the automated run-time adaptation of software, which takes the form of middleware. Moreover, it is particularly interesting to note that the adaptation mechanisms are based on process technologies. It should also be noted that—using an internalised approach like the one described in this document—the target application ends up being strictly interconnected with the run-time adaptation facilities and, in effect, it cannot practically exist without them.

With specific regard instead to externalised software run-time adaptation, the work by Gail Kaiser “Autonomizing Legacy Systems”, Almaden Institute Symposium on Autonomic Computing, 10-12 Apr. 2002 illustrates the fact that the functional architecture of a platform for externalised software run-time adaptation can essentially be seen to include a series of interoperating roles, i.e.:

an observation role, which continuously monitors the relevant aspects of the target application, generating corresponding information;

an analysis role, which processes the monitoring information to evaluate the state of the target application at any time and recognise significant conditions that would require some form of adaptation;

a decision role, which uses the analysis produced by the previous component, to decide when the adaptation intervention is necessary, and which actions need to be taken;

a co-ordination role, to act as a result of the decision made by the previous component in order appropriately to organise, orchestrate, invoke and control the adaptation actions to be carried out on one or more components of the target application; and

an actuation role, which implements the aforesaid adaptation actions or interventions with specific software entities (called effectors) directed by the co-ordinating component and having the desired side effects on the target application.

The aforementioned work also notes the fact that externalised architectures allow to address the runtime adaptation of pre-existing (legacy) systems and services, as well as systems and services that comprise some third-party components.

The work by G. Valetto “Process-Orchestrated Software: Towards a Workflow Approach to the Coordination of Distributed Systems” generically proposes to study the use of process/workflow technology to develop an automated co-ordination solution for externalized run-time software adaptation.

The work by G. Knight et al. “The Willow Architecture: Comprehensive Survivability for Large-Scale Distributed Applications” represents in many ways the closest technique to the solution proposed herein. This in particular regards the usage of process technology to automate and co-ordinate, by means of an external platform, adaptation interventions on distributed software applications.

It should be noted that, in regard to the granularity aspect, the system described in the last document mentioned describes only architecture-level adaptations, hence relatively coarse-grained. In fact, the method described in the document in question is substantially aimed at solving the problem of the survivability of a system comprising distributed components, mainly through (re-)deployment interventions, that is, interventions that entail the possibility of (re)dislocating, migrating or differently (re)assembling the target application in its entirety, considered in terms of its main components, their interconnections and their location in the network. No consideration is given to those adaptations which may have effects on the more internal elements of one or more such components, for instance at the level of the programming modules or of individual attributes within one or more components and modules.

It should also be noted that, in regard to the scope of intervention, the system described in the document by Knight et al. is limited, as stated previously, to consider the problem of the survivability of the target application. This fact is understandable, since survivability can be achieved by adaptations performed at the global architecture level, as described above. Other types of problems, such as performance optimisation or other functional and extra-functional tuning, in fact require much finer-grained adaptations and therefore are excluded from the scope of application of the document in question. Additionally, it is apparent that, in this known solution, the side effects on the target application are left to the responsibility of a limited set of effectors, implemented in the form of a proprietary deployment facility.

Instead, it is important to be able to take into account and interact with a broad range of effectors deriving from different technologies, with the specific purpose of uncoupling the co-ordination of adaptation interventions from the implementation and execution of the side effects on the target application, thereby being able to cover a wide repertory of effectors and application domains.

More in general, there is the need to provide a software run-time adaptation solution able to assure not just the survival but also the management and optimisation of a system comprising distributed components and to intervene, if necessary, also within individual components.

### SUMMARY OF THE INVENTION

The present invention is aimed at meeting said requirement, overcoming the aforementioned limitations of the prior art.

According to the present invention, said aim is achieved thanks to a method having the characteristics specifically recalled in the claims that follow. The invention also relates to a corresponding software platform, and to a telecommunications or data processing network that uses said platform, in particular in relation to services for distributed users, such as a personal instant messaging service. Lastly, the invention also relates to a corresponding computer product, able to be loaded directly into the memory of one or more computers and comprising portions of software codes able to implement the method according to the invention when the product is executed on a computer.

The invention is suitable to be embodied as a process engine (also sometimes called a workflow engine), capable of interacting with a broad range of software technologies.

The invention embodies a fully automated solution for the run-time adaptation of distributed software from the exterior, which can act at different granularity levels and for a vast range of targets.

Specifically, within a conceptual architecture like the one described in the previously mentioned document by G. Kaiser, the invention is focused on the need to achieve the co-ordination and control of adaptation decisions and actions to be able, in particular, completely to automate the decision and co-ordination roles within such an externalised platform.

More in detail, the invention adopts an approach based on process technology to perform the aforesaid decision and co-ordination roles.

A process (alternatively also indicated in the relevant art as a workflow) can be thought of as a collection of work units (usually referred to with terms such as tasks, activities or steps) with certain relationships and dependencies, regarding the control and data flow among tasks. A process engine is a software entity, possibly distributed, capable of receiving, loading and interpreting a specification of a process expressed in a machine executable form and of executing, thereby automatically enacting the process according to its specifications.

As regards the run-time adaptation of software, the process engine starts the execution examining the data received from the analysis role of the externalised run-time adaptation platform. On this basis, the process decides whether to start enacting any process and which process to enact. The execution, within the engine, of some of the tasks defined in this process can be associated to side effects on the target applications. These side effects take on the form of software codes (effectors) capable of being invoked by the process engine and of carrying out said side effects.

The invention provides for the presence of a uniform program interface between process and effectors, configured to interact with the effectors in a transparent fashion with respect to the technological implementation peculiarities of the effectors themselves. Preferably, the interface has an effector repository associated thereto, as well as an actuation module for selecting, instancing, invoking and managing effectors according to the tasks enacted in the process.

Compared to process-based co-ordination solutions for the run-time externalised adaptation of software (such as those mentioned in the previously mentioned article by Knight et al.), the solution described herein has numerous advantages.

In regard to granularity, the solution described herein does not formulate any hypothesis or assumption, nor does it set any limitation on the level of granularity of the adaptations to co-ordinate. Granularity can vary from the modification of the target application as a whole, which has an effect on the overall architecture through the creation, elimination or replacement of components and connectors, to the modification of the inner elements (modules) of one or more components, and even to the modification of individual working parameters, or of sets of such parameters, within individual modules.

Moreover, the solution described herein remains independent from the conceptual and technological approaches used to implement the effectors of the target application.

In regard to its employment and the scope of the adaptations that can be implemented—and consequently of the two characteristics seen previously—the solution described herein is versatile and can be used for various purposes, among which can be mentioned (without any limiting intent): the automated deployment and starting of target applications in a given execution environment, the distribution and re-deployment of software updates or new releases of the same application, the modification of the distribution and configuration of the target application on the network, the modification of the interaction models (i.e. the connectors) between the target components, the dynamic scaling of the application in response to load variations, the optimisation and fine tuning of specific parameters that regulate the operation or the behaviour of the target application, of its subsystems and components, as will be made more readily evident by the application examples provided below.

The solution described herein has numerous additional advantages.

In particular, the externalised adaptation approach entails no additional requirements for the target application, which need not be developed taking into account adaptation requirements or providing for a coding or, otherwise, the provision, at the design or implementation level, of specific measures destined to allow adaptation.

Consequently, the adaptation can be superimposed in minimally intrusive fashion to the target applications. These can be both applications inherited from the past (so-called legacy applications), third party applications and/or applications which are not completely under the control of those who manage the adaptation solution, which allows to encompass a far broader range of potential targets.

As an additional consequence, the types of adaptation capable of being carried out on a target application and the control logic that governs these adaptations can be modified without modifying the target application in any way.

In direct contrast with internalized solutions that provide for somehow inserting into individual components of the target application certain elements destined to allow adaptations, which are able to treat the administration and optimisation of those components in isolation, an externalized platform like the one described herein has the advantage of being aware of, and being able to operate on the system as a whole. It thereby can better achieve end-to-end optimisations by means of global adaptation policies.

Moreover, the solution described herein has specific advantages linked to the choice of process-based technology.

Processes are particularly suited to describe co-ordination requirements between multiple entities, hence to enable adaptations involving multiple target components in a concerted fashion.

The definition of global and rather complex adaptation policies, such that would involve a considerable quantity of entities subject to adaptation and to require numerous actions with precise causal, time or logic dependencies, can be also specified out in a simple manner.

Process specifications can also be expressed with high level formalisms, and thus do not necessarily require particularly sophisticated programming abilities to define the aforesaid co-ordination policies.

The fact of employing process specifications also contributes to the clear separation of the co-ordination aspects from the computation details involved in implementing a specific code for the effectors, which therefore interfere only marginally, or do not interfere at all, with adaptation policies.

Process evolution, modification and maintenance are also usually less challenging and costly than maintenance of normal software. In particular, new processes can be conceived off line and then loaded into the process engine later, without disrupting its functionality.

Additional advantages of the solution described herein derive from the specific preferred implementation solution.

In preferred fashion, the process engine used is a fully decentralised software system, which allows efficiently to co-ordinate even large scale target applications, capable of being widely dispersed on the network environment. This using multiple, distributed and semi-autonomous instances of the engine which remain connected and interact as specified.

Preferably, means are provided for dynamically loading new process specifications into the distributed process engine. This allows to provide new and/or updated forms of adaptation at practically zero cost with respect to the operation of the target application and without disrupting the adaptation facilities.

The implementation of the solution described herein can easily be inserted in the core of a platform for externalised software run-time adaptation. This thanks to the employment of specific functional interfaces which regulate its interaction with the other major elements of a platform for externalised software run-time adaptation.

The implementation of the solution described herein comprises flexible interfaces which allow any facility able to perform the analysis role to pass the data resulting from its own analysis to the process engine. These data are interpreted by the engine as triggers for the adaptation process.

The integration between the process and the actuation role is obtained by means of a program interface which allows tasks to invoke effectors according to requirements, to specify their target and all other necessary parameters, then retrieve the results of the execution of the effectors. This interface enables to achieve independence relative to any chosen technological option for effectors. These options naturally strongly depend on the nature, on the implementation and on the technological underpinnings of the target components with which they are to interact, and include (without any limiting intent) Remote Procedure Calls, mobile codes, message passing and asynchronous events.

The solutions described herein also allows to choose whether to co-opt the decision role within the process engine itself, or to delegate it to an external decision system, which may be as complex as needed by the application context. Such an external decision system can be easily integrated as a helper application for the process engine, which retains its co-ordination role.

### BRIEF DESCRIPTION OF THE DRAWINGS

The invention shall now be described purely by way of a non limiting example, with reference to the accompanying drawings, in which:

FIG. 1 is a first functional block diagram illustrating the context of application of the solution described herein,

FIG. 2 is an additional block diagram representing said solution, and

FIG. 3 illustrates in greater detail the structure of the interface module between processors and effectors included in the diagram of FIG. 2.

### DETAILED DESCRIPTION OF A PREFERRED EMBODIMENT OF THE INVENTION

As a premise, it shall be recalled once again that the solution described herein falls within the context of a complete platform with externalised software adaptation functions in run-time conditions, able to carry out the roles of observation, analysis, decision, co-ordination and actuation discussed above. It is assumed that the observation, analysis and actuation roles are provided as separate components relative to the solution specifically described herein, but interacting therewith.

The solution described herein can be used in a broad range of software run-time adaptation scenarios including heterogeneous multi-component target applications, distributed in a network environment which may either be local (i.e. at the LAN or Intranet level) of global (i.e. at the WAN and Internet level in general).

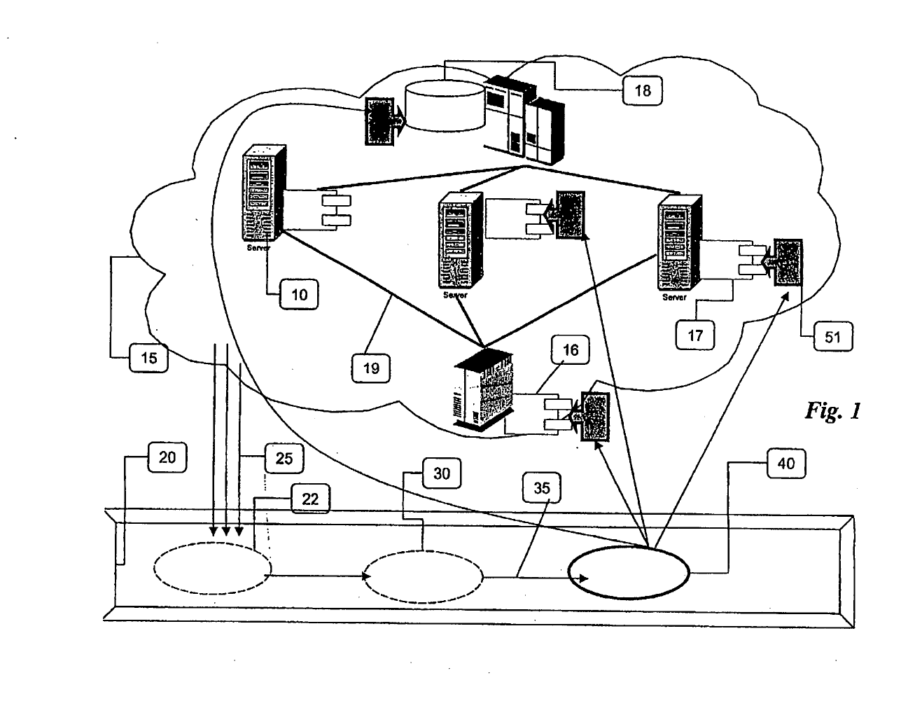

In essence, with reference to the diagram of FIG. 1, scenarios of this kind can be characterised by a series of host machines (10) configured in a network 15 whereon reside computational components 17 and data components 18 of the target application. These components interact by means of so-called connectors 19.

FIG. 1 shows a particular example, seen as a preferred embodiment. In this example, the target application is organised as a so-called three tiered application.

In particular, a server 16 that plays the front-end role receives incoming requests from the clients of the application and re-addresses them to a set of identical middle-tier components, which operate as a group or cluster of servers to satisfy these requests.

This is accomplished by accessing, as required, a back-end tier with a data memory with persistent state thanks to a database system 18.

In the externalised adaptation platform 20, the observation module 22 (of a known type, which makes superfluous a detailed description herein) continuously monitors the distributed system and forwards the monitoring information 25 to an analysis module 30 (also known, thus rendering superfluous a detailed description thereof).

Based on this information, the analysis module produces significant reports on the state of the target application.

The system described herein uses these reports as trigger events 35 for a process engine 40: As a result of any adaptation process, the engine 40 decides to carry out and co-ordinate a set of computational actions 51 (called effectors), which impact on the various target components 17.

Experimental Results

The organisation of the example described herein reflects the structure of an Internet based multi-channel instant messaging service, whereon the solution described herein was tested wholly successfully at the prototype level.

In the specific example considered herein, a significant form of adaptation that has been experimented with is linked to run-time adaptation issues such as automated deployment, automated configuration, automated fault recovery, automated service administration, on-the-fly scalability, on-the-fly performance tuning, which are achieved in the aforementioned prototype in the way described below.

Application Deployment:

On request, the process engine 40 firstly starts up and begins to enact one or more tasks in parallel which entail the issuing of appropriate effectors to middle-tier hosts 10, with the purpose of instantiating new identical server instances, which provide the initial setup of the instant messaging service cluster. This phase of the process addresses the runtime adaptation issue of automated application deployment.

Application Configuration:

Following each successful instantiation, the process enacts follow-up tasks that issue effectors with the purpose to configure the instantiated middle-tier service components 17 to interact with one another 17 in the fashion of a cluster, as well as to correspondingly and simultaneously update the tables and the policies within the front-end server (16) for routing and balancing the request load among the active elements of the cluster. This phase of the process addresses the runtime adaptation issue of automated configuration of the target application.

On the Fly Service Scalability:

Furthermore, whenever an opportune trigger is reported to the process by the analysis module 30, signifying an excessive request load on a cluster or one of its components, the process enacts a chain of tasks analogous to those described above, aiming at instantiating and configuring a new middle-tier service component 17 on some other available host and to add it to the cluster. This phase of the process addresses the run-time adaptation issue of automated performance optimisation of the service, in this specific case providing service scalability on the fly.

Automated Fault Recovery:

Furthermore, whenever an opportune trigger is reported to the process by the analysis module, signifying that—because of some kind of fault—a component has crashed on the host it resides upon and is not available anymore, the process can decide to enact a chain of tasks analogous to those described above, aiming at instantiating and configuring a new instance of the same service component 17 on the same host, thus the restoring the working configuration and the full fucntionality of the service. This phase of the process addresses the run-time adaptation issue of automated fault recovery.

On-the-Fly Performance Tuning:

Furthermore, whenever an opportune trigger is reported to the process by the analysis module 30, signifying an excessive delay by any middle-tier service component 17 in servicing the requests routed to it from the front-end server 16, the process enacts a task that issues an effector 51 onto the impacted component, which modifies its internal request queue and enhances its degree of parallelism in serving incoming requests. This phase of the process also addresses the run-time adaptation issue of automated performance optimisation of the service, in this specific case via on-the-fly parameter tuning for enhanced performance within a single component.

Automated Service Administration:

Furthermore, on request, the process can enact a specific sequence of tasks that allows to update the release of the service software residing on all the hosts taking part in the service with so-called “patches” and software updates of any of the components. This is achieved by shutting down one by one each active outdated release of each middle-tier component and deploying, instantiating and configuring in its place the newly updated release. Thus, the process incrementally upgrades the service software without shutting down the service as a whole and in a transparent fashion for the service users. This phase of the process addresses the run-time adaptation issue of automated administration and in this particular case the service staging.

According to this preferred embodiment, the described system operates as a decision and co-ordination core of an end-to-end solution for the externalised software run-time adaptation of the messaging system mentioned above.

The tests conducted by the Applicant have shown that the solution described herein is able to completely automate the adaptation decisions and actions, bringing about a broad range of beneficial effects both for users and for the provider of the service.

At the user level, employment of the solution described herein is perceived as an improvement to Quality of Service (QoS), especially in conditions of particularly heavy loaded of the service, or of degradation in the service, or of some of its components, and/or of the interconnecting network.

The provider instead, thanks to the automation of the decisions and of the interventions, achieves substantial economies in the response to critical conditions which may emerge in the service.

Considerable savings are also achieved in terms of effort, and hence cost, for the management and administration of the target applications when conditions suitable for being automatically and autonomously handled by the solution described herein occur.

Moreover, an important factor is an increased service up-time: automatic adaptation interventions do not require deactivating the system and its components.

Lastly, resource optimisation is obtained, since the dynamic nature of the adaptations allows to re-compute and to vary the quantity of resources allocated to the service as required, eliminating or at least minimising over-provisioning.

Although purely representative and not exhaustive, the examples of adaptation whereto reference is made above show that they have an effect on target applications at very different grain sizes.

The solution described herein allows to conceive and enact adaptation processes which are able to operate with an appropriate choice of said effectors in a co-ordinated manner, thereby obtaining the desired effects.

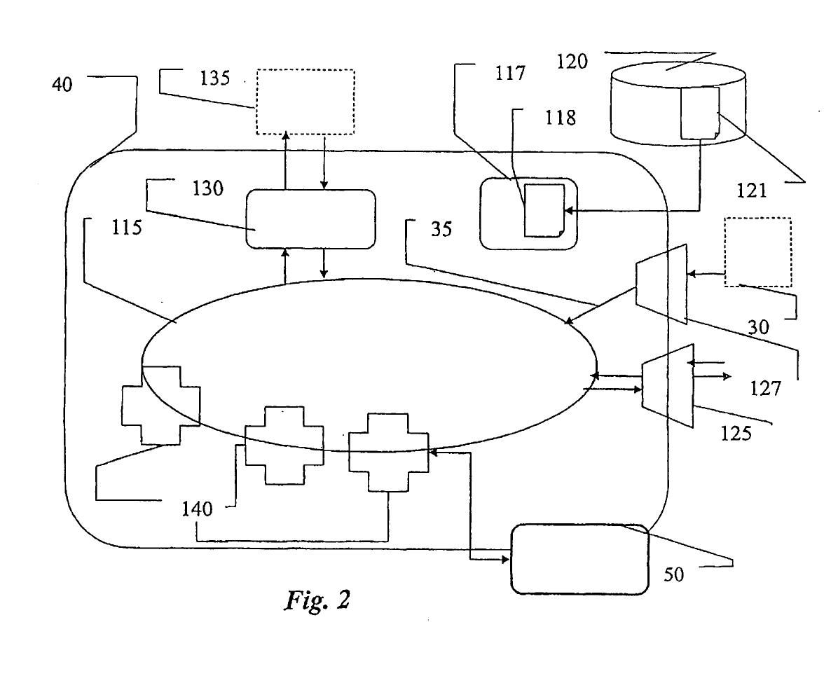

Examining the diagram of FIG. 2, the reference 115 designates an internal data management module, destined to capture and manage in consistent fashion all information needed to enact the process.

Therefore, these are the input and output data from the process engine from and to the external software entities, for any purpose, of the internal representation of the process and of its state, as loaded by a corresponding module (better described below) and as manipulated at the moment of enactment by execution facilities (also better described below), together with the information about the process repository and the effector repository. These modules, too, shall be described below.

The data management module 115 provides the other modules of the process engine with global information about the data it manages, access privileges and, symmetrically, access restrictions, as well as controlled modes to use and manipulate the related data with a constant degree of consistency and updating.

The reference 117 designates a process loading module. This module is destined to receive some process specifications 112 and to carry out actions intended to cause said specifications to be properly represented in a form that is somehow executable within the process engine.

These steps may entail the interpretation in an internal format of some formalism suitable to be executed, instancing other computational modules with auxiliary functions in the engine, destined to be appropriately invoked during process execution, producing internal data and data schemes representing the state of the process and so on.

Irrespective of the means adopted to load the process, the logic of this step is completely incorporated in the process loading module.

The module 117 is able to load multiple processes in the module, both simultaneously and incrementally.

In particular, the loading step can be performed both in “push” mode and in “pull” mode.

The push mode is implemented by an entity (a user, or another software) which asks the loading module 117 to load a determined process specification.

The pull mode instead is implemented by the process engine itself, which is able to react to some event (for example a process trigger, as will become more readily apparent below) asking the loading module 117 to search for determined process specifications.

In both cases, it is possible to use an optional component 120 serving as process repository. In practice, it is a database that is able to store and make available on request a certain number of process specifications 121.

The reference 125 instead designates data exchange modules. In practice, there is a certain number of utilities that allow data input and output relative to external programs. Input data must be converted into adequate formats suited to be used within the process engine for its purposes, in particular to capture the state of the target application, as well as of the adaptation platform as a whole.

The output data can represent the by-product of the execution of the process engine and can be of interest for exterior entities, possibly after suitable re-formatting. The data exchange modules 125 can operate both in batch mode (i.e. reading/writing data relative to the data memories in asynchronous mode), or in a stream mode (directly communicating with other applications being executed which produce/immediately consume the exchanged data).

At least another data exchange module 127 (whose presence is mandatory) serves as a communication channel from the analysis role of the adaptation platform to the process engine. The module 127 is used is used to transfer any result from the external analysis module of the platform 30. In practice, it is a certain set of appropriately coded data which constitutes a direct input for the adaptation process, thus serving the role of process trigger 35.

There is also a decision module 130 destined to evaluate any trigger data received from the analysis function of the external platform and to select—whenever it is necessary—one or more processes associated to said trigger and which must be enacted in response.

The simplest way to associate trigger and adaptation processes is to define either pattern matching mechanisms or query mechanisms which connect the format and the content of the incoming triggers and the process specifications received from the loading module 117.

It is also possible to use a computing unit with decision function 135, which is completely independent and external.

The unit 135 accesses the data received by the process engine and the set of defined process specifications and encapsulates any specific logic employed to oversee the decision step.

At the end, the module 135 that serves as the decision maker communicates its results to the process engine, through the module 130, and it may request the loading and startup of an adaptation process.

Using an external decision facility allows to isolate the decision logic, which can be quite complex in the case of large scale target applications and for their adaptation. It is thereby possible more clearly to separate decision aspects (for instance which process—if any—is the best suited to achieve a certain adaptation under given conditions) from co-ordination aspects (i.e. how to enact the selected process according to its specifications and doing so effectively for its purposes).

The reference 140 designates the modules dedicated to process execution. These are appropriate mechanisms, within the process engine, with the responsibility of assuring the execution of a loaded process, according to its specifications. The facilities take on the form of one or more computational modules destined to interpret the loaded process representation and incrementally to modify its state—maintained internally to the process engine. The overall process state is composed by the state of the tasks, of the data and of the resources described within the process and by the dependencies between tasks.

The exact semantics of the state information and of the way it is to be interpreted and updated is the responsibility of the process execution facilities 140, depending on the process specification.

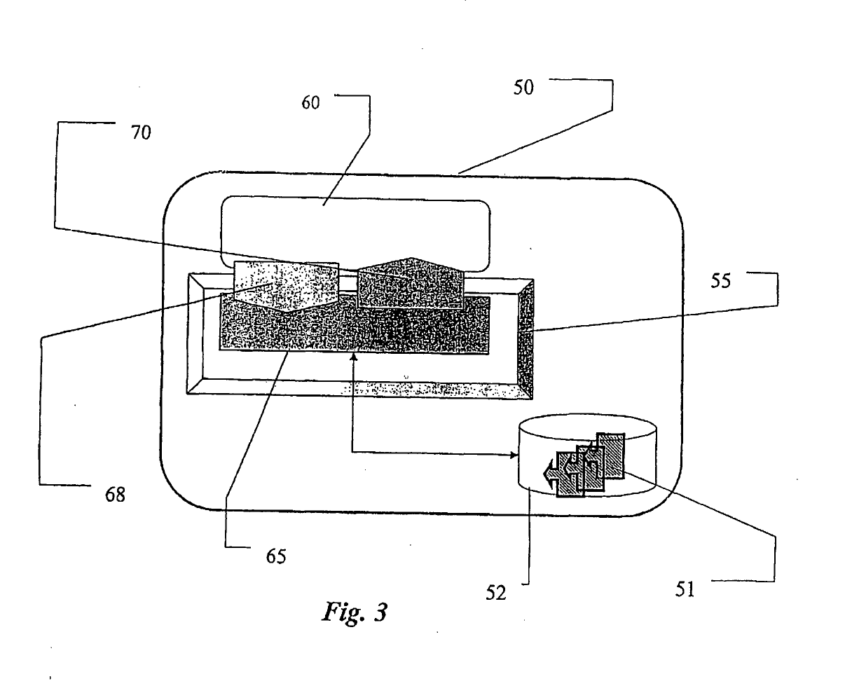

An important role within the solution described herein is performed by the actuation sub-system designated as 50 and illustrated in detail in FIG. 3.

The role of this sub-system is to orchestrate under the guidance of the modules 140 the effectors destined to be instanced to achieve adaptation on the target application.

The sub-system 50 is constituted by some essential components.

The first component is a so-called repository 52 of the effectors. In practice, this is a memory with the ability of preserving descriptions and code artefacts for the effectors 51. These are computational elements capable of being used by the process to obtain side effects on the target application, in order to obtain its run-time adaptation.

Also provided is an actuation module 60 with the function of choosing, instancing, invoking and administering the most appropriate effectors. This takes place using the actuation interface, better described below, as a result and by order of the tasks enacted in the process and destined to obtain side effects on the target application.

The aforementioned interface, designated as 55, has the main purpose of hiding any idiosyncrasy linked to the possible specific technological characteristics of different implementations of the effectors 51, to interact with said effectors in transparent fashion with respect to the implementation technologies of the effactors 51 themselves.

This interface has considerable importance since it provides a uniform manner to interact with the effectors and co-ordinate them.

Within the interface 55, a certain number of functional blocks can be identified.

In the first place there is a facility 65 able to query the repository 52, allowing to choose, instance and invoke the code artefacts that constitute the effectors.

There is also a facility used by the aforementioned actuation module 60 to pass the parameters from the process tasks to the selected effectors 68.

Lastly, there is a complementary facility 70 which the actuation module 60 uses to retrieve the results deriving from work performed by the effectors and convey them back to the corresponding process tasks. This can take place for instance by exploiting the data exchange modules 25 shown in FIG. 2.

The solution described herein is implemented on the basis of and as an extension of an open-source project, whose original code base is freely available. The described modules are implemented as independent basic units able to be mixed and adapted at will by means of simple initial configuration directives of the process engine.

Preferably, to load one or more processes by a user/administrator the push mode is used, whilst a loaded process is specified through a set of computational objects which correspond to determined code configurations and which are instantiated upon loading within the process engine and invoked directly by the process execution facilities while the process is enacted.

For the effectors, a mobile code technology has preferably (but not exclusively) been used. In practice, the effectors are implemented as mobile codes containing a specific application logic based on the knowledge of the application context. Such mobile codes complete the route towards the components of the target application whereon they are to have an impact and are executed in their execution space.

The actuation module 60 is integrated with the mobile code technology by means of the interface 55 mentioned previously.

The data exchange module which represents the channel for the analysis results (trigger) to the process engine was implemented successfully as a receiver of streams of asynchronous events generated externally with respect to the engine. These are parsed and re-formatted on the fly, according to requirements for representing data internal to the engine.

Both for the decision module, in order to select the given process with respect to a given input trigger, and for the actuation module, to connect the tasks to their desired side effects, represented by the effectors, and thereby be able to choose the suitable effectors from the repository, it is possible to use a simple association mechanism based on pattern matching.

There may also be a web-based interface to monitor the process enacted within the process engine and for auditing and testing purposes.

Naturally, without changing the principle of the invention, construction details and embodiments may vary widely with respect to what is described and illustrated herein, without thereby departing from the scope of the present invention.

For example (and naturally the list that follows should not be construed to have any intent of limiting the scope of the invention), different variants may be considered with respect to the preferred embodiment described above.

For example, one can think of using the pull mode for the loading module 117. This could be done by providing that as a reaction to an input trigger which is not yet associated with any loaded process specification, the process specification may be sought by means of a query to a process repository 120, able to be located remotely relative to the instance being executed of the process engine that issues the request.

As mentioned above, it is also possible to use an external decision component 135, closely integrated and destined to support the process engine in its decision role. This takes place by establishing a dedicated interfacing and data exchange module 130 destined to convey information elements useful for the decision process and return the decisions to the process engine.

The effectors could also be implemented in the form of a stream of asynchronous messages exchanged between the process engine and the target components to be adapted. The actuation module uses the same actuation program interface 55 as the other effector implementations to generate events representative of its adaptation directives towards the target components and possibly receive the connected information, such as the results of the adaptation carried out as a result of a directive.

It is possible to extend the repertory of technologies capable of being used for the effectors, in particular to technologies for remotely invoking operations made available by the target components, according to a Remote Procedure Call paradigm and different variants of said paradigm currently used in distributed computing. Correspondingly, it is possible to adapt the programming interface to take into account such other technologies in such a way that it remains transparent with respect to the actuation module of the process engine.

It is also possible to use, instead of a single centralised process engine, multiple decentralised instances to enact an adaptation process. The multiple instances can both manage the enactment of independent but coexisting sub-processes relating to aspects of the same process, loosely coupled to each other, or also the same process operating on disjoint sets of components included in the same target application distributed on a large scale. The inter-exchange of information about the state of the process or of other useful information between the instances of the process engine remaining transparent relative to the process can be achieved by exploiting the native distribution capabilities of the open-source software used as the basis of the preferred embodiment.

More generally, and as an additional variation, the solution described herein can be used not only to adapt a target application but also (and simultaneously) to reconfigure in run-time conditions the platform itself, which externally supervises the adaptation of said target application. This way of operating can be characterised as “meta-adaptation” and meets the vision of a self-regulating platform for external run-time adaptation of software systems. The described co-ordination engine can thus be used to intervene on any of the other components of the platform in question, in particular the monitoring and analysis components, for their management, updating and other forms of behavioural and functional modifications to the platform itself. All this whilst these components remain in operation within the platform.

Additionally, the solution described herein can be used in conjunction with any appropriate high level process specification formalisms, and which are then automatically transformed into a format executable by the loading module 117.

1-39. (canceled)

40. A method for managing distributed systems comprising:
processing modules based on the execution of at least a process within a process engine, the process entailing interventions for run-time adaptation of said processing modules, such interventions being carried out through effectors, the method comprising the step of:
providing a uniform actuation interface configured to interact with said effectors.

41. The method as claimed in claim 40, comprising the step of associating to said actuation interface a repository of said effectors.

42. The method as claimed in claim 40, comprising the step of associating to said actuation interface an actuation module driven by the process to select, instance, invoke and manage said effectors as a function of the tasks enacted in the process.

43. The method as claimed in claim 41, wherein said effectors comprise code artefacts and comprising the step of providing in said actuation interface a query facility to query said repository to select, instance and invoke the code artefacts comprised into said effectors.

44. The method as claimed in claim 42, comprising the step of providing in said interface a re-sending facility to pass parameters from said task to the selected effectors.

45. The method as claimed in claim 42, comprising the step of associating to said actuation interface, a complementary facility to convey to the corresponding tasks the results deriving from the intervention of the effectors as selected.

46. The method as claimed in claim 44, comprising the step of associating to said actuation interface, a complementary facility to convey to the corresponding tasks the results deriving from the intervention of the effectors as selected.

47. The method as claimed in claim 40, comprising the step of providing a process loading module able to receive process specifications and to provide the representation of said specification in a form executable by a process engine.

48. The method as claimed in claim 47, wherein said step of providing the representation of said specification in turn comprises at least one step selected from the group: interpretation of formalisms in an internal executable format, instancing other auxiliary computational modules within the process engine, and production of representation of the process state.

49. The method as claimed in claim 48, comprising the step of providing a set of processing elements forming an integral part of said process engine for implementing said at least one step.

50. The method as claimed in claim 49, wherein said processing elements operate within a process state constituted by the state of the tasks of the data and of the resources described in the process and by the related dependencies between the tasks.

51. The method as claimed in claim 47, comprising the step of causing said loading module process to operate in push mode with loading request sent to said process loading module by an external event.

52. The method as claimed in claim 47, comprising the step of causing said process loading module to operate in pull mode with request to the process loading module to perform a loading operation formulated by the process engine itself.

53. The method as claimed in 47, comprising the step of providing in association with said process loading module, a process repository component to make available on request a set of process specifications.

54. The method as claimed in claim 40, comprising the step of providing data exchange modules to allow the exchange of data with respect to external programs.

55. The method as claimed in claim 40 comprising the step of providing an external module with the function of analysing said adaptation interventions and the step of providing a respective data exchange module, to receive from said external module input data capable of constituting process triggers.

56. The method as claimed in claim 40, comprising the step of providing a decision module to evaluate trigger events and select interventions associated to said trigger events to be carried out in response to said trigger events.

57. The method as claimed in claim 47, comprising the step of defining mechanisms for connecting said trigger events and the process specifications received through said process loading module.

58. The method as claimed in claim 56, comprising the step of defining mechanisms for connecting said trigger events and the process specifications received through said process loading module.

59. The method as claimed in claim 56, comprising the step of using an external decision module with access to the data received from the engine of said process and from related process specifications.

60. A platform for managing distributed systems comprising processing modules based on the execution of at least one process within a process engine, the process entailing interventions for run-time adaptation of said processing modules, said interventions being conducted by means of effectors, the platform comprising a uniform actuation interface capable of interacting with said effectors.

61. The platform as claimed in claim 60, comprising a repository of said effectors associated with said interface.

62. The platform as claimed in claim 60, comprising an actuation module associated with said interface and driven by a process for selecting, instancing, invoking and managing said effectors according to the tasks enacted in the process.

63. The platform as claimed in claim 61, wherein said effectors are comprised of code artefacts and said interface comprises a query facility for interrogating said repository to select, instance and invoke the code artefacts comprised into said effectors.

64. The platform as claimed in claim 62, wherein said interface comprises a facility for passing parameters from said task to the effectors as selected.

65. The platform as claimed in claim 62, wherein said interface comprises a complementary facility for conveying to the corresponding tasks the results deriving from the intervention of the effectors as selected.

66. The platform as claimed in claim 64, wherein said interface comprises a complementary facility for conveying to the corresponding tasks the results deriving from the intervention of the effectors as selected.

67. The platform as claimed in claim 60, comprising a process loading module able to receive process specifications and to assure the representation of said specifications in a form that is executable by a process engine.

68. The platform as claimed in claim 67, wherein said process loading module is further able to assure at least one operation selected from the group: interpretation of formalisms in an executable internal code, instancing other auxiliary computational modules within the process engine, and production of representations of the state of the process.

69. The platform as claimed in claim 68, comprising a set of processing elements which are an integral part of said process engine for the implementation of said at least one operation.

70. The platform as claimed in claim 69, wherein said processing elements for the execution of the process operate within a process state constituted by the state of the tasks, of the data and of the resources described in the process and by the related dependencies between the tasks.

71. The platform as claimed in claim 67, wherein said process loading module is configured to operate in push mode with loading request sent to said process loading module by an external event.

72. The platform as claimed in claim 67, wherein said process loading module is configured to operate in pull mode with request to the process loading module to perform a loading operation formulated by the process engine itself.

73. The platform as claimed in claim 67, comprising, in association with said process loading module, a process repository component to make available on request a set of process specifications.

74. The platform as claimed in claim 60, comprising data exchange modules to allow the exchange of data with respect to external programs.

75. The platform as claimed in claim 60, comprising an external module serving the function of analysing said adaptation interventions associated therewith, and comprising a respective data exchange module to receive from said external module input data able to constitute process triggers.

76. The platform as claimed in claim 60 comprising a decision module to evaluate trigger events and select interventions associated with said trigger events to be carried out in response to said trigger events.

77. The platform as claimed in claim 67 comprising a mechanism for connecting said trigger events and the process specifications received by means of said process loading module.

78. The platform as claimed in claim 76, comprising a mechanism for connecting said trigger events and the process specifications received by means of said process loaded module.

79. The platform as claimed in claim 76, comprising an external decision module associated therewith with access to the data received from the engine of said process and from related process specifications.

80. A network for telecommunication services based on a platform as claimed in claim 60.

81. A network as claimed in claim 80, wherein said platform supervises a personal messaging system of said network.

82. A computer program product able to be loaded directly into the memory of at least a computer and comprising portions of software codes for implementing the method as claimed in any one of claims 40 to 59, when the product is capable of being executed on a computer.
